(19) United States
(12) Patent Application Publication
(10) Pub. No.: US 2022/0171463 A1
(43) Pub. Date: Jun. 2, 2022

(54) DISPLAY DEVICE AND TOUCH FEEDBACK METHOD

(71) Applicant: AU Optronics Corporation, HSIN-CHU (TW)

(72) Inventors: Ya-Ting CHEN, HSIN-CHU (TW); Sheng-Wen CHENG, HSIN-CHU (TW)

(21) Appl. No.: 17/468,084

(22) Filed: Sep. 7, 2021

(30) Foreign Application Priority Data
Nov. 30, 2020 (TW) 109142119

(51) Int. Cl. G06F 3/01; G06F 3/041

(52) U.S. Cl. CPC G06F 3/016; G06F 3/0414

(57) ABSTRACT

A touch feedback method, including: by a touch circuit, detecting a contact object with a display device and generating a corresponding detection signal; determining a degree of displacement of the contact object according to the detection signal; when the displacement amplitude is less than a displacement threshold, driving a vibration circuit to make the vibration circuit vibrate in a first mode; and when the displacement amplitude is greater than the displacement threshold, driving the vibration circuit to make the vibration circuit vibrate in a second mode.

### CROSS-REFERENCE TO RELATED APPLICATION

This application claims priority to Taiwan Application Serial Number 109142119, filed Nov. 30, 2020, which is herein incorporated by reference in its entirety.

### BACKGROUND

### Technical Field

The present disclosure relates to a display device, especially a circuit and method for generating a touch feedback by a vibration circuit of a display panel.

### Description of Related Art

With the rapid development of electronic technology, display devices are widely used in daily life, and have more and more functions. The touch function is a common basic function of the display device, which can be used to detect the position of the user's finger on the display panel and the contact pressure. In order to provide consumers with a more convenient operation mode, a major issue at present is that the display device has an interactive function that cooperates with the touch function.

### SUMMARY

One aspect of the present disclosure is a touch feedback method, comprising the following steps: detecting, by a touch circuit, a contact object with a display device and generating a detection signal; determining a displacement amplitude of the contact object according to the detection signal; driving a vibration circuit to make the vibration circuit vibrate in a first mode when the displacement amplitude is less than a displacement threshold; and driving the vibration circuit to make the vibration circuit vibrate in a second mode when the displacement amplitude is greater than the displacement threshold.

Another aspect of the present disclosure is a display device, comprising a display panel, a touch detection unit and a touch feedback unit. The touch detection unit is configured to detect a touch operation between the display device and a contact object to obtain a detection signal. The touch detection unit is further configured to determine a displacement amplitude of the contact object according to the detection signal. The touch detection unit is further configured to generate a first touch sensing signal when the displacement amplitude is less than a displacement threshold, and is further configured to generate a second touch sensing signal when the displacement amplitude is greater than the displacement threshold. The touch feedback unit is electrically coupled to the touch detection unit. The touch feedback unit is configured to receive the first touch sensing signal to drive a vibration circuit to vibrate in a first mode, and the touch feedback unit is further configured to receive the second touch sensing signal to drive the vibration circuit to vibrate in a second mode.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a display device in some embodiments of the present disclosure.

FIG. 2 is a schematic diagram of the display device in some embodiments of the present disclosure.

FIG. 3A-FIG. 3C are schematic diagrams of the vibration circuit and the vibration characteristics in some embodiments of the present disclosure.

FIG. 4 is a schematic diagram of the driving signal in some embodiments of the present disclosure.

FIG. 5 is a flowchart illustrating a touch feedback method in some embodiments of the present disclosure.

FIG. 6A-FIG. 6B are schematic diagrams of driving signal output by the feedback controller in some embodiments of the present disclosure.

FIG. 7A-FIG. 7B are schematic diagrams of driving signal of the vibration circuit in the first mode in some embodiments of the present disclosure.

FIG. 8 is a schematic diagram of driving signal of the vibration circuit in the first mode in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” includes an associated listed items or any and all combinations of more.

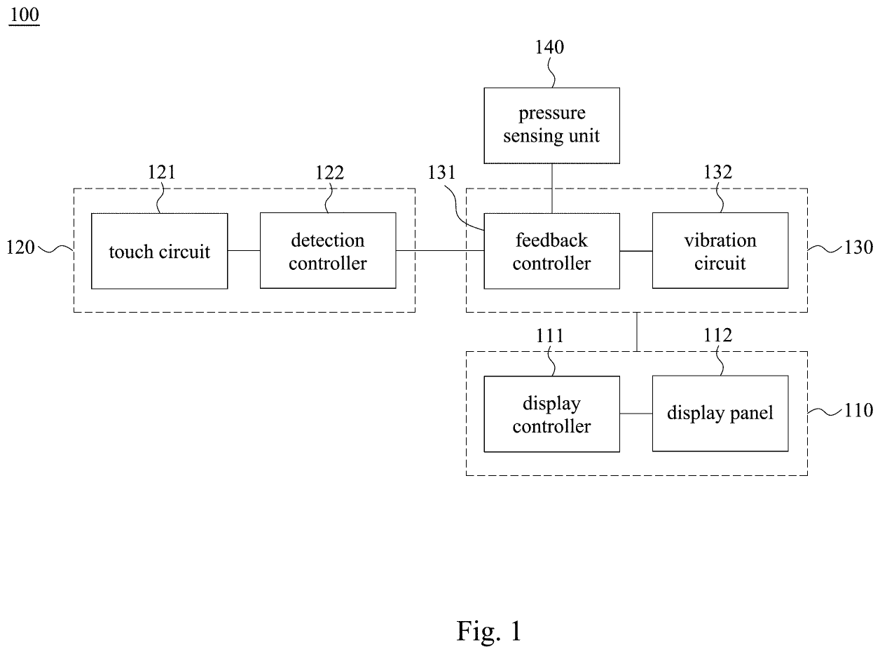

FIG. 1 is a schematic diagram of a display device in some embodiments of the present disclosure. The display device 100 includes a display unit 110, a touch detection unit 120 and a touch feedback unit 130. The display unit 110 includes a display controller 111 and a display panel 112. The display controller 111 provides a display signal to the display panel 112, so that the display panel 112 displays the corresponding screen by multiple pixel circuits. The display panel 112 can be implemented as LCD, OLED or micro-LED display, but not limited to this.

The touch detection unit 120 includes a touch circuit 121 and a detection controller 122. The touch circuit 121 is configured to detect a touch operation between the display device 100 and a contact object (e.g., the user's finger) to generate a detection signal corresponding to the touch operation (contact object). In some embodiment, the touch circuit 121 can be implemented as a touch panel, and is arranged above or below the display panel 112. That is, when the user's finger touches the display device 100, the finger touches the touch circuit 121 (touch panel), and the touch circuit 121 can detect the corresponding position of the finger, and obtains the position corresponding to the display panel 112. In some embodiments, the touch detection unit 120 is a capacitive touch technology, which determines the contact position by detecting changes in capacitance between multiple electrodes, but the present disclosure is not limited to this.

The detection controller 122 is electrically coupled to the touch circuit 121, and is configured to determine a displacement amplitude of the contact object according to the detection signal transmitted by the touch circuit 121. For example, determining whether the user's finger stays on the display panel 112, or slides on the display panel 112. The detection controller 122 generates different detection signals according to the determining result of the displacement amplitude. The detection method of the displacement amplitude will be explained in the subsequent paragraphs.

The touch feedback unit 130 includes a feedback controller 131 and a vibration circuit 132. The feedback controller 131 is electrically coupled to the detection controller 122 and the vibration circuit 132, and is configured to drive the vibration circuit 132 according to the detection signal transmitted by the detection controller 122. In one embodiment, the vibration circuit 132 is configured to generate at least two different axial (direction) vibrations.

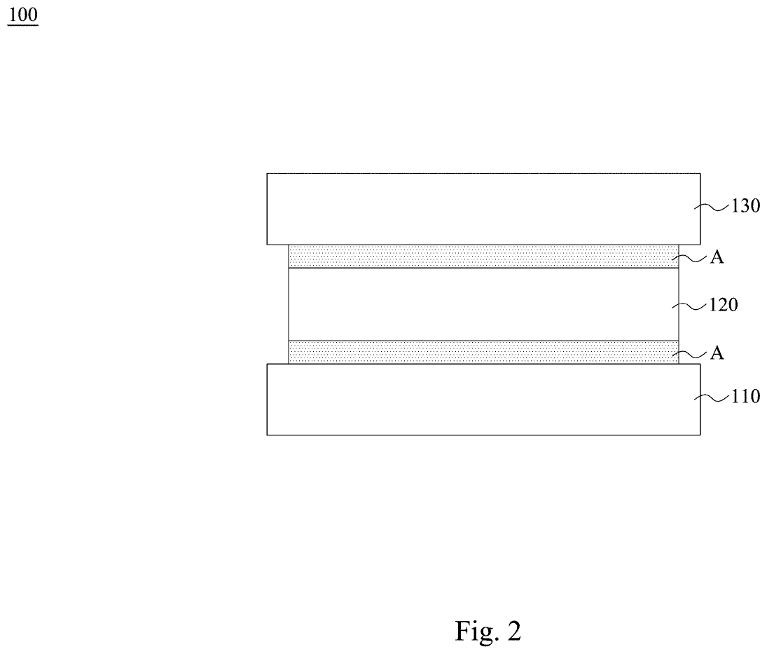

The position of the vibration circuit 132 is adjacent to the display panel 112 to drive the display panel 112 to generate vibrations and feedback the vibrations to the contact object (e.g., the user's fingers). FIG. 2 is a schematic diagram of the display device 100 in some embodiments of the present disclosure. The display unit 110, the touch detection unit 120 and the touch feedback unit 130 are assembled into one device by adhesion A. In some embodiment, the touch detection unit 120 and the touch feedback unit 130 are arranged above on the display unit 110, and the touch circuit 121 (touch panel) of the touch detection unit 120 is transparent, so the user can observe the display panel 110 through the transparent panel of the touch detection unit 120. In some other embodiments, the touch detection unit 120 and the touch feedback unit 130 are sequentially bonded under the display unit 110.

In one embodiment, after determining the displacement amplitude of the contact object, the touch detection unit 120 further determine whether the displacement amplitude is greater than a displacement threshold. The displacement threshold may be a preset displacement distance, a displacement speed or a duration of the displacement. If the displacement amplitude is less than the displacement threshold, it represents that the contact object has not moved. At this time, the detection controller 122 will transmit the first touch sensing signal to the feedback controller 131, so that the feedback controller 131 controls the vibration circuit 132 to operate in the first mode according to the first touch sensing signal. On the other hand, if the displacement amplitude is greater than or equal to the displacement threshold, it represents that the contact object is moving on the display panel 112. At this time, the detection controller 122 will transmit the second touch sensing signal to the feedback controller 131, so that the feedback controller 131 controls the vibration circuit 132 to operate in the second mode according to the second touch sensing signal.

As mentioned above, when the vibration circuit 132 operates at the first mode and the second mode, the vibration circuit 132 generates vibration in different ways to present different feedback effects. In some embodiments, when the vibration circuit 132 operates at the first mode, the vibration circuit 132 vibrates along the first direction. When the vibration circuit 132 operates at the second mode, the vibration circuit 132 vibrates along the second direction. The first direction can be a horizontal direction parallel to the display panel 112, and the second direction can be a vertical direction perpendicular to the display panel 112. That is, the first direction and the second direction are orthogonal to each other, but the present disclosure is not limited to this.

On the other hand, the vibration circuit 132 can further change the vibration waveform or the vibration frequency according to different modes. For example, when the vibration circuit 132 is operating at the first mode, the detection controller 122 transmits the first touch sensing signal (e.g., a “no displacement” signal) to the feedback controller 131. The feedback controller 131 sets the driving signal at the first frequency according to the first touch sensing signal, and then outputs the driving signal to the vibration circuit 132. At this time, the vibration circuit 132 will vibrate with the first frequency as the vibration frequency and generate the vibration waveform. In contrast, when the vibration circuit 132 is operating at the second mode, the detection controller 122 transmits the second touch sensing signal (e.g., a “displacement” signal) to the feedback controller 131. The feedback controller 131 sets the driving signal at the second frequency according to the second touch sensing signal, and then outputs the driving signal to the vibration circuit 132. At this time, the vibration circuit 132 will vibrate with the second frequency as the vibration frequency and generate the vibration waveform. The first frequency and the second frequency are not the same, or are frequency sections of the first frequency and the second frequency do not overlap each other. The vibration frequency of the vibration circuit 132 is between 100 and 500 Hz. In some embodiments, the first frequency is between 100 and 300 Hz, and the second frequency is between 300 and 500 Hz.

In some embodiment, when the vibration circuit 132 operates at different modes, both of the vibration direction and the vibration frequency at different modes are different. For example, the vibration circuit 132 vibrates along the first direction with the first frequency at the first mode. The vibration circuit 132 vibrates along the second direction with the second frequency and in the second mode.

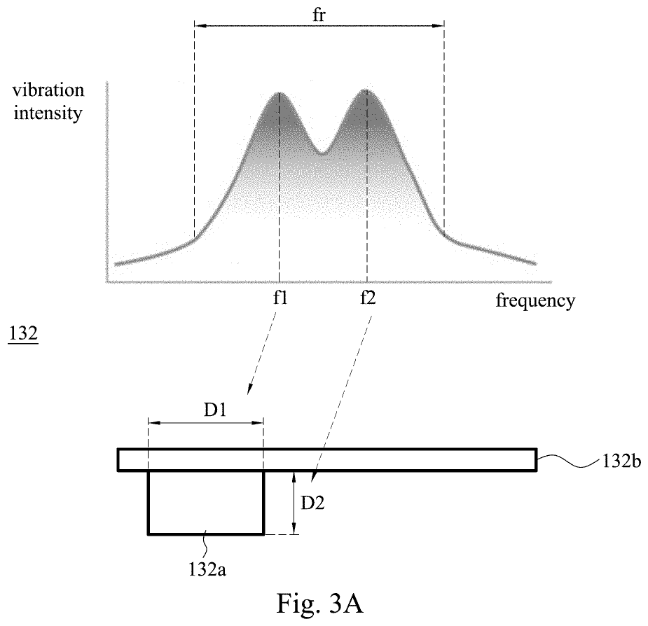

FIG. 3A is a schematic diagram of the vibration circuit 132 and the vibration characteristics in some embodiments of the present disclosure. Specifically, the vibration circuit 132 includes a biaxial controller 132a and a touch vibration plate 132b. The biaxial controller 132a has at least two axial vibration directions and two corresponding vibration frequencies to drive the touch vibration plate 132b. When the feedback controller 131 receives the first/second touch sensing signal, the feedback controller 131 sets the driving signal at the first/second frequency so that the biaxial controller 132a vibrates along the first direction D1 or the second direction D2. In some embodiments, the biaxial controller 132a of the vibration circuit 132 can be implemented by a linear resonance actuator (LRA) or a Piezo actuator. The vibration circuit 132 (the biaxial controller 132a) will use the first/second frequency in the driving signal as the vibration frequency. Since one skilled in the art can understand the structure and vibration principle of the vibration circuit 132 (the biaxial controller 132a), it will not be repeated here.

Referring to FIG. 2 and FIG. 3A, in some embodiments, since the touch feedback unit 130 is usually an opaque element, the touch feedback unit 130 can be arranged on the display device 100 close to the display unit 110 or the outside of the touch detection unit 120 to avoid affecting the display area (AA area) of the display panel 112. For example, the vibration circuit 132 is arranged on the left and right sides of the display device 100 (FIG. 2); or the biaxial controller 132a is arranged on the left and right sides of the touch vibration plate 132b (FIG. 3A).

As shown in vibration characteristics of FIG. 3A, the vertical axis of vibration characteristics is vibration intensity (G value or m/s²), and the horizontal axis of vibration characteristics is frequency (Hz). In the broad haptic range fr of the biaxial controller 132a, the first frequency f1 and the second frequency f2 are the most obvious resonance peaks, which can make the biaxial controller 132a produce the most obvious vibration. For example, the first frequency f1 corresponds to the first direction D1, and the second frequency f2 corresponds to the second direction D2. Therefore, the state of the vibration circuit 132 operating with the first frequency f1 can be referred to as “the first mode”, and the state of the vibration circuit 132 operating with the second frequency f2 can be referred to as “the second mode”. The operation of the vibration circuit 132 or the waveform of the driving signal in the present disclosure is not limited to that shown in FIG. 3A. According to different types of the vibration circuit, there can be more than three operation modes. For example, the first frequency, the second frequency and the third frequency have obvious and different vibration effects.

FIG. 3B and FIG. 3C are schematic diagrams of the biaxial controller 132a and the vibration characteristics in some embodiments of the present disclosure. The vertical axis of vibration characteristics is vibration intensity (G value or m/s²), and the horizontal axis of vibration characteristics is frequency (Hz). As shown in FIG. 3B, when the vibration circuit 132 operates at the first mode, the first frequency f1 in the driving signal is set to about 160 Hz, and the biaxial controller 132a vibrates along the first direction D1. As shown in FIG. 3C, when the vibration circuit 132 is operating at the second mode, the second frequency f2 in the driving signal is set to about 310 Hz, and the biaxial controller 132a vibrates along the second direction D2.

In above embodiments, when the vibration circuit 132 vibrates along the first direction D1 (w.g., the horizontal direction parallel to the display panel 112), it is the first mode; when the vibration circuit 132 vibrates along the second direction D2 (e.g., the vertical direction), it is the second mode. In some other embodiments, the vibration circuit 132 may have a third mode. For example, the vibration circuit 132 vibrates along the first direction D1 and the second direction D2, and the ratio of the vibration intensity is 1:2. This mixe vibration mode in different directions is used as the third mode.

With the vibration circuit 132 vibrating at different modes, when the user's finger touches the display panel 112, or slides on the display panel 112, there will be a different tactile sensation to simulate a special material (e.g., wood pattern, marble pattern).

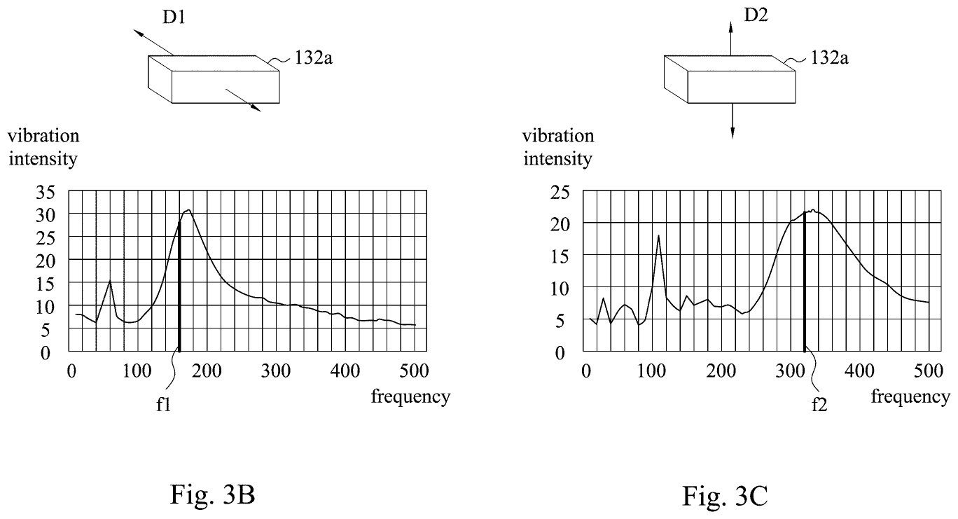

FIG. 4 is a schematic diagram of the display screen 400 displayed by the display device 100 in some embodiments of the present disclosure. In one embodiment, the display device 100 is used in vehicle panels. The display screen 400 displayed by the display panel 112 includes images with special materials (e.g. wood pattern, marble pattern). With the above different modes of the vibration circuit 132, when the user touches the display device 100 with a finger F, or slides a track on the display screen 400, they will feel different touches, just like touching a real wooden board.

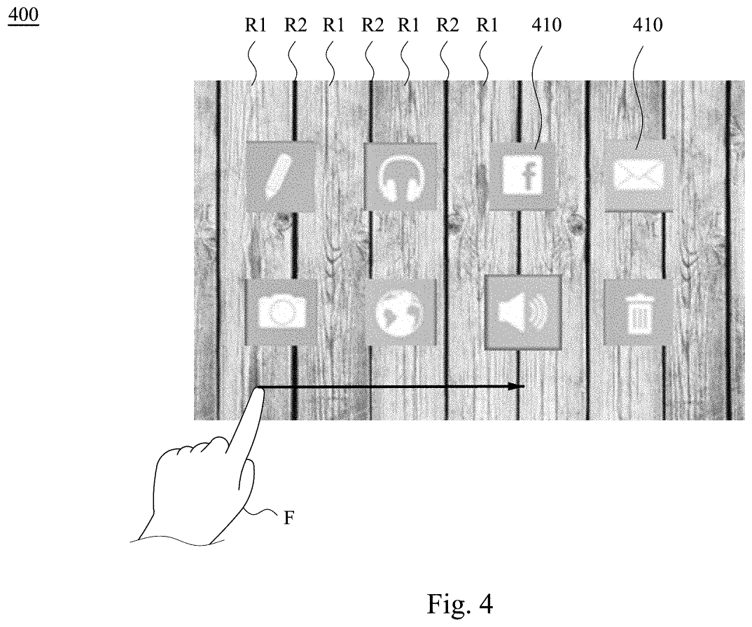

FIG. 5 is a flowchart illustrating a touch feedback method in some embodiments of the present disclosure, including the following steps S501-S505. In step S501, the touch detection unit 120 detects the touch circuit 121 (touch panel) and the touch operation of the contact object to generate the corresponding detection signal. As shown in the structure diagram of the display device 100 in FIG. 2, the “touch operation” means that the user's finger touches the touch detection unit 120, and a potential or capacitance change occurs between the finger and the touch detection unit 120 to generate the detection signal. In some other embodiments, with the different structures of the display device 100, “the touch operation” can further be a distance between the user and the touch detection unit 120, so that sensing element (e.g. electrode) of the touch detection unit 120 changes in electrical properties.

In step S502, the touch circuit 121 transmits the detection signal to the detection controller 122 to calculate the displacement amplitude of the contact object. In some embodiment, the detection signal includes a coordinate position of the contact object. The detection controller 122 determines a change of the coordinate position within a detection time, and calculate the displacement speed and the displacement direction according to the change. In step S503, the detection controller 122 further determines whether the displacement amplitude is greater than the displacement threshold. In some other embodiments, the detection controller 122 generates the first touch sensing signal or the second touch sensing signal according to the displacement speed, so as to change the vibration frequency of the vibration circuit 132. For example, the faster the displacement speed, the higher the vibration frequency.

For example, during the detection time, if the coordinate position of the detection signal detected by the touch circuit 121 changes from (2,0) to (2.2,0), since the displacement distance is only 0.2 and the displacement amplitude is less than the displacement threshold (e.g., 1), the contact object can be regarded as not moving. Conversely, during the detection time, if the coordinate position of the detection signal detected by the touch circuit 121 changes from (2,0) to (15,0), since the displacement distance is 13, the displacement amplitude is greater than the threshold value, the contact object can be confirmed that sliding on the display panel 112.

In step S504, when the displacement amplitude is less than the displacement threshold, the detection controller 122 transmits the first touch sensing signal to the feedback controller 131, so that the feedback controller 131 sets the driving signal at the first frequency, and drives the vibration circuit 132 to operate at the first mode. The vibration circuit 132 will vibrate along the first direction.

In step S505, when the displacement amplitude is greater than the displacement threshold, the detection controller 122 transmits the second touch sensing signal to the feedback controller 131, so that the feedback controller 131 sets the driving signal at the second frequency, and drives the vibration circuit 132 to operate on at second mode. The vibration circuit 132 will vibrate along the second direction.

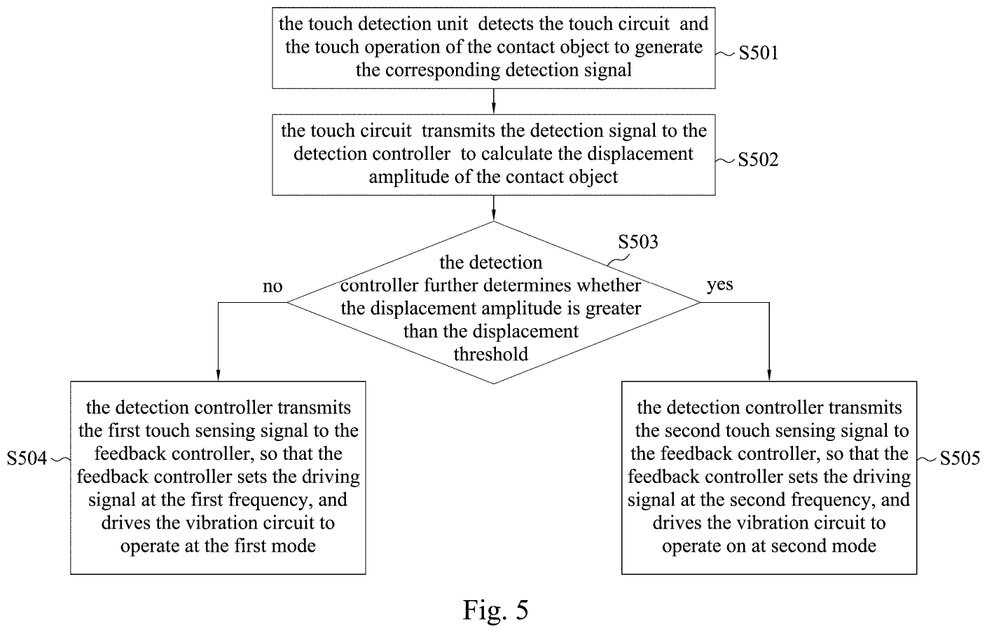

FIG. 6A-FIG. 6B are schematic diagrams of driving signal output by the feedback controller 131 (or the vibration waveform of the vibration circuit 132) in some embodiments of the present disclosure. As shown in FIG. 6A, in some embodiment, when the feedback controller 131 sets the first frequency f1 to the frequency of the driving signal, the amplitude of the driving signal changes with time. As shown in FIG. 6B, when the feedback controller 131 sets the second frequency f2 to the frequency of the driving signal, the driving signal takes the form of a square wave signal.

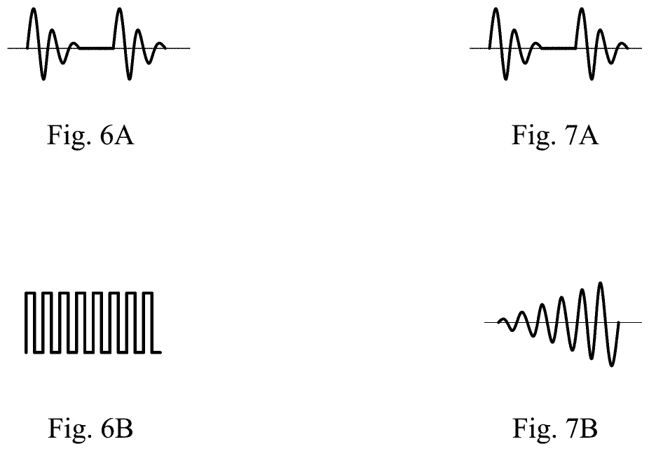

FIG. 7A-FIG. 7B are schematic diagrams of driving signal of the vibration circuit 132 (or the vibration waveform of the vibration circuit 132) in the first mode in some embodiments of the present disclosure. As shown in FIG. 7A, the amplitude of the driving signal changes with time. As shown in FIG. 7B, in some other embodiments, the driving signal can be gradually increased over time.

Referring to FIG. 1, FIG. 4 and FIG. 7A-FIG. 7B, the feedback controller 131 can selectively change the form of the driving signal according to the contact pressure or the contact position of the contact object. In one embodiment, the display device 100 further includes a pressure sensing unit 140. The pressure sensing unit 140 is electrically coupled to the touch circuit 121 and/or the feedback controller 131, and is configured to detect the contact pressure applied when the contact object contacts the display unit 110 or the touch detection unit 120. The change of the vibration waveform includes frequency, amplitude and waveform (e.g. sine wave or pulse wave). For example, when the contact pressure is greater than a preset value, the feedback controller 131 adjusts the driving signal so that the vibration waveform of the vibration circuit is changed from the waveform shown in FIG. 7A to the waveform shown in FIG. 7B.

As mentioned above, in some other embodiments, when the stop position of the contact object corresponds to the position of the icon 410 in the user interface 400, the feedback controller 131 generates the driving signal with the waveform in FIG. 7A. When the stop position of the contact object does not correspond to the position of the icon 410 in the user interface 400, the feedback controller 131 generates the driving signal with the waveform in FIG. 7B.

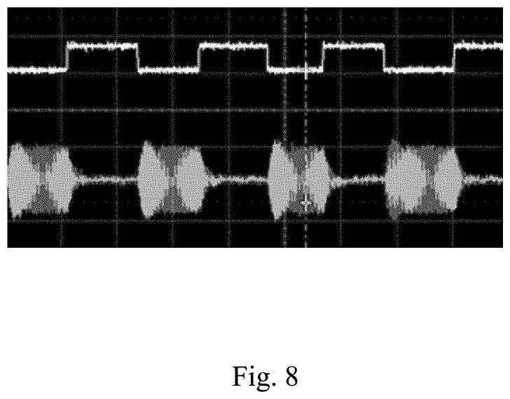

In some embodiment, referring to FIG. 1, FIG. 4 and FIG. 8, the display device 100 can selectively drive the vibration circuit 132 according to the position of the contact object. The display device 100 has multiple first regions R1 and multiple second regions R2. The first regions R1 and the second regions R2 correspond to the display panel 112 and the touch circuit 121. As shown in FIG. 4, positions of the first regions R1 and the second regions R2 are staggered in the display screen 400. When the position of the contact object corresponds to one of the first regions R1, the detection controller 122 outputs the first touch sensing signal/the second touch sensing signal to the touch feedback unit 130. Conversely, when the position of the contact object corresponds to one of the second regions R2, the detection controller 122 stops outputting the first touch sensing signal/the second touch sensing signal to the touch feedback unit 130. At this time, the feedback controller 131 further stops driving the vibration circuit 132.

FIG. 8 is a schematic diagram of driving signal of the vibration circuit 132 in the first mode in some embodiments of the present disclosure. As shown in figure, the detection controller 122 outputs the first touch sensing signal/the second touch sensing signal and a region detection signal to the feedback controller 131. As shown in the upper waveform in FIG. 8, the region detection signal can be a square wave composed of high and low potentials to represent that the contact object corresponds to the first regions R1 or the second regions R2. For example, when the contact object is in the first regions R1, the region detection signal will be at the enable level (e.g., low voltage), and the detection controller 122 will output the driving signal to the feedback controller 131. On the other hand, when the contact object is in the second regions R2, the region detection signal will be at the disable level (e.g. high voltage), at this time, the detection controller 122 will stop outputting the driving signal to the feedback controller 131, ensuring that the vibration circuit 132 will not vibrate at the first mode or the second mode.

The present disclosure makes the touch feedback unit 130 to use a smaller number of vibration sources to achieve single point feedback and simulate texture feedback to generate multiple tactile feedback, so as to improve the interactive reality of the display device 100.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A touch feedback method, comprising:
detecting, by a touch circuit, a contact object with a display device and generating a detection signal;
determining a displacement amplitude of the contact object according to the detection signal;
driving a vibration circuit to make the vibration circuit vibrate in a first mode when the displacement amplitude is less than a displacement threshold; and
driving the vibration circuit to make the vibration circuit vibrate in a second mode when the displacement amplitude is greater than the displacement threshold.

2. The touch feedback method of claim 1, wherein the vibration circuit vibrates along a first direction during the first mode, the vibration circuit vibrates along a second direction during the second mode, and the second direction is different from the first direction.

3. The touch feedback method of claim 2, wherein the first direction and the second direction are orthogonal to each other.

4. The touch feedback method of claim 1, wherein the vibration circuit vibrates with a first frequency during the first mode, the vibration circuit vibrates with a second frequency during the second mode, and the second frequency is different from the first frequency.

5. The touch feedback method of claim 1, further comprising:
determining a contact position of the display device corresponding to the contact object;
driving the vibration circuit to operation at the first mode or the second mode when the contact position is in one of a plurality of first regions; and
stoping driving the vibration circuit when the contact position is in one of a plurality of second regions.

6. The touch feedback method of claim 5, wherein positions of the plurality of first regions and positions of the plurality of second regions are staggered.

7. The touch feedback method of claim 1, wherein the detection signal comprises a coordinate position of the contact object, and determining the displacement amplitude of the contact object comprises:
determining a change of the coordinate position within a detection time; and
calculating a displacement speed according to the change of the coordinate position.

8. The touch feedback method of claim 7, further comprising:
adjusting a vibration frequency of the vibration circuit according to the displacement speed.

9. A display device, comprising:
a display panel;
a touch detection unit, configured to detect a touch operation between the display device and a contact object to obtain a detection signal, wherein the touch detection unit is further configured to determine a displacement amplitude of the contact object according to the detection signal; the touch detection unit is further configured to generate a first touch sensing signal when the displacement amplitude is less than a displacement threshold, and is further configured to generate a second touch sensing signal when the displacement amplitude is greater than the displacement threshold; and
a touch feedback unit, electrically coupled to the touch detection unit, wherein the touch feedback unit is configured to receive the first touch sensing signal to drive a vibration circuit to vibrate in a first mode, and the touch feedback unit is further configured to receive the second touch sensing signal to drive the vibration circuit to vibrate in a second mode.

10. The display device of claim 9, wherein the vibration circuit vibrates along a first direction during the first mode, the vibration circuit vibrates along a second direction during the second mode, and the second direction is different from the first direction.

11. The display device of claim 10, wherein the first direction and the second direction are orthogonal to each other.

12. The display device of claim 9, wherein the vibration circuit vibrates with a first frequency during the first mode, the vibration circuit vibrates with a second frequency during the second mode, and the second frequency is different from the first frequency.

13. The display device of claim 9, wherein the touch detection unit is further configured to determine a contact position of the display panel corresponding to the contact object; the touch detection unit transmits a first touch sensing signal or the second touch sensing signal to the touch feedback unit when the contact position is in one of a plurality of first regions; and the touch detection unit stops transmits the first touch sensing signal or the second touch sensing signal to the touch feedback unit when the contact position is in one of a plurality of second regions.

14. The display device of claim 13, wherein positions of the plurality of first regions and positions of the plurality of second regions are staggered.

15. The display device of claim 13, wherein the detection signal comprises a coordinate position of the contact object, the touch detection unit is configured to determine a change of the coordinate position within a detection time to calculate a displacement speed of the contact object.

16. The display device of claim 15, wherein the touch detection unit is configured to generate the first touch sensing signal or the driving detection signal according to the displacement speed to change a vibration frequency of the vibration circuit.

17. The display device of claim 9, further comprises:
a pressure sensing unit, configured to detect a contact pressure between the contact object and the display panel or between the contact object and the touch detection unit.

18. The display device of claim 17, wherein the touch detection unit or the touch feedback unit is configured to adjust a vibration waveform of the vibration circuit according to the contact pressure.
